(19) United States
(12) Patent Application Publication
(10) Pub. No.: US 2026/0332316 A1
(43) Pub. Date: Oct. 22, 2026

(54) OVERRULING OF A PUSCH CLUSTER IN XR TRAFFICS

(71) Applicant: Apple Inc., Cupertino, CA (US)

(72) Inventors: Ralf Rossbach, Munich (DE); Fangli Xu, Beijing (CN); Ping-Heng Kuo, London (GB)

(21) Appl. No.: 19/113,804

(22) PCT Filed: Sep. 30, 2022
(86) PCT No.: PCT/CN2022/123377

§ 371 Date: Mar. 20, 2025

(51) Int. Cl. H04L 1/1867; H04L 5/00; H04W 72/115

(52) U.S. Cl. CPC H04L 1/1896; H04L 5/0044; H04W 72/115

(57) ABSTRACT

Methods, systems, apparatuses, and computer programs for setting a start point of an overruled configured grant timer value are disclosed. In one aspect, the method can include processing a dynamic grant received on PDCCH for the UE's C-RNTI that overrules a configured grant for the PUSCH transmission cluster, and changing an association between the configured grant and the PUSCH transmission cluster for a predetermined amount of time.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

According to one innovative aspect of the present disclosure, method, to be performed by a UE, for handling dynamic grant overruling of a configured grant for a PUSCH transmission cluster is disclosed. In one aspect, the method can include processing a dynamic grant received on PDCCH for the UE's C-RNTI that overrules a configured grant for the PUSCH transmission cluster, and changing an association between the configured grant and the PUSCH transmission cluster for a predetermined amount of time.

Other aspects includes apparatuses, systems, and computer programs for performing the actions of the aforementioned method.

The innovative method can include other optional features. For example, in some implementations, changing an association between the configured grant and the PUSCH transmission cluster for a predetermined amount of time can include removing the association of the configured grant with the PUSCH transmission cluster while the dynamic grant overrules the configured grant.

In some implementations, changing an association between the configured grant and the PUSCH transmission cluster for a predetermined amount of time can include removing the association of the configured grant with the PUSCH transmission cluster until a configured grant timer associated with the configured grant expires.

In some implementations, changing an association between the configured grant and the PUSCH transmission cluster for a predetermined amount of time can include enabling a HARQ process of the PUSCH transmission cluster that is associated with the configured grant to be overwritten while the dynamic grant overrules the configured grant.

According to another innovative aspect of the present disclosure, a method, to be performed by a UE, for handling dynamic grant overruling of a configured grant for a PUSCH transmission cluster is disclosed. In one aspect, the method can include processing a configured grant received on PDCCH corresponding to a plurality of PUSCH transmission, starting a single timer relating to a plurality of HARQ processes at a particular time, wherein each HARQ process of the plurality of HARQ processes corresponds to a PUSCH transmission of the plurality of PUSCH transmissions, processing a dynamic grant received on PDCCH for the UE's C-RNTI that overrules the configured grant for a particular PUSCH transmission the plurality of PUSCH transmissions, and starting an overruled configured grant timer at a start time that is based on the particular time.

Other aspects includes apparatuses, systems, and computer programs for performing the actions of the aforementioned method.

The innovative method can include other optional features. For example, in some implementations, the method can further include refraining from performing a new transmission on one or more configured grant resources associated with one or more of the plurality of HARQ processes when the single timer is running.

In some implementations, the method can further include refraining from performing a new transmission on one or more configured grants associated with a HARQ process that is associated with the particular PUSCH transmission when the overruled configured grant timer is running.

In some implementations, the particular time that the single timer starts corresponds to is: (i) at a beginning of a first PUSCH transmission of the plurality of PUSCH transmissions, or (ii) after a termination of a last PUSCH transmission of the plurality of PUSCH transmissions.

In some implementations, starting an overruled configured grant timer at a start time that is based on the particular time can include starting the overruled configured grant timer at the same time as the particular time that the single timer relating to a plurality of HARQ processes is started.

In some implementations, the particular time that the single timer starts corresponds to a time that is different than (i) at a beginning of a first PUSCH transmission of the plurality of PUSCH transmissions, or (ii) after a termination of a last PUSCH transmission of the plurality of PUSCH transmissions.

In some implementations, starting an overruled configured grant timer at a start time that is based on the particular time can include starting the overruled configured grant timer at a time that is a function of the particular time that the single timer relating to a plurality of HARQ processes is started and an offset.

In some implementations, the offset accounts for a length from the beginning of the first PUSCH transmission or a termination of the last PUSCH transmission.

In some implementations, the offset is a predetermined length.

In some implementations, the offset is negative.

According to another innovative aspect of the present disclosure, a method, to be performed by a UE, for handling dynamic grant overruling of a configured grant for a PUSCH transmission cluster is disclosed. In one aspect, the method can include processing, a configured grant corresponding to a plurality of PUSCH transmissions, wherein each PUSCH transmission of the plurality of PUSCH transmissions is associated with one HARQ process of a plurality of HARQ processes, starting a set of configured grant timers relating to the plurality of HARQ processes, processing a dynamic grant received on PDCCH for the UE's C-RNTI that identifies a particular HARQ process and overrules a configured grant for a particular PUSCH transmission of the plurality of PUSCH transmissions to which the identified HARQ process corresponds, and restarting one configured grant timer of the set of configured grant timers that is related to the identified HARQ process using a predetermined timer value.

Other aspects includes apparatuses, systems, and computer programs for performing the actions of the aforementioned method.

The innovative method can include other optional features. For example, in some implementations, the method can further include refraining from performing a new transmission on one or more configured grants associated with the identified HARQ process that is associated with the particular PUSCH transmission when the restarted configured grant timer is running.

In some implementations, the predetermined timer value is a remainder of an initial duration of the configured grant timer related to the identified HARQ process that causes the configured grant timer related to the particular HARQ process to expire at a common expiry point established for one or more other HARQ processes corresponding to another respective PUSCH transmission of the plurality of PUSCH transmissions.

In some implementations, the method can further include determining that the overruling dynamic grant does not occur at the same periodic time as the configured grant, and adjusting the predetermined timer value by an offset.

In some implementations, determining that the overruling dynamic grant does not occur at the same periodic time as the configured grant can include determining that the overruling dynamic grant occurs at a later time than the configured grant and before a common expiry point for the set of grant timers. In such implementations, adjusting the predetermined timer value by an offset can include adjusting the predetermined timer value by a negative offset.

In some implementations, the dynamic grant received via PDCCH includes the offset.

In some implementations, the predetermined timer value is a based on a default timer value associated with the configured grant timer.

In some implementations, the method can further include receiving a HARQ-ACK for the particular HARQ process identified by the dynamic grant, and stopping the configured grant timer related to the identified HARQ process.

According to another innovative aspect of the present disclosure, a method, to be performed by a UE, for handling dynamic grant overruling of a configured grant for a PUSCH transmission cluster is disclosed. In one aspect, the method can include processing a dynamic grant received on PDCCH for the UE's C-RNTI that identifies a particular HARQ process of a plurality of HARQ processes associated with a plurality of PUSCHs and overrules a configured grant for a particular PUSCH transmission of the plurality of PUSCH transmissions to which the particular HARQ process corresponds, suspending consideration of the identified HARQ process with a single configured grant timer related to the plurality of HARQ processes, and starting a different configured grant timer related to the identified HARQ process that is set to a predetermined timer value.

Other aspects includes apparatuses, systems, and computer programs for performing the actions of the aforementioned method.

The innovative method can include other optional features. For example, in some implementations, the method can further include refraining from performing a new transmission on one or more configured grants associated with the identified HARQ process that is associated with the particular PUSCH transmission when the different configured grant timer is running.

In some implementations, the predetermined timer value is based on a default timer value.

In some implementations, the predetermined timer value is based on the single configured grant timer related to the plurality of HARQ processes.

In some implementations, the predetermined timer value is based on the single configured grant timer related to the plurality of HARQ processes and an offset.

In some implementations, the method can further include determining that the overruling dynamic grant occurs after the configured grant and before expiry of the single configured grant timer and then setting the offset to a negative offset.

In some implementations, the method can further include receiving a HARQ-ACK for the particular HARQ process identified by the dynamic grant, and stopping the different configured grant timer related to the identified HARQ process.

According to another innovative aspect of the present disclosure, a method, to be performed by a UE, for setting a value of a common expiration point is disclosed. In one aspect, the method can include processing, a configured grant corresponding to a plurality of PUSCH, wherein each PUSCH transmission of the plurality of PUSCH transmissions is associated with one HARQ process of a plurality of HARQ processes, starting a set of configured grant timers relating to the plurality of HARQ processes, processing one or more dynamic grants received on PDCCH for the UE's C-RNTI that each (i) identify a particular HARQ process and (ii) overrule a configured grant for a particular PUSCH transmission of the plurality of PUSCH transmissions a to which the identified HARQ process corresponds, for each of the processed dynamic grants: restarting one configured grant timer of the set of configured grant timers that is related to the HARQ process identified by the processed dynamic grant using a predetermined timer value, and considering, by the UE, (i) each of the one or more restarted configured grant timers and (ii) the remaining set of configured grant timers until a common expiration point associated with (i) each of the one or more restarted configured grant timer and (ii) the remaining set of configured grant timers is reached.

In some implementations, the method can further include stopping the set of timers at the common expiration point.

In some implementations, determining that multiple dynamic grants have been processed, and based on determining that multiple dynamic grants have been processed, adjusting the common expiration point associated with (i) each of the one or more restarted configured grant timer and (ii) the remaining set of configured grant timers.

In some implementations, determining that the plurality of PUSCH transmissions is associated with one or more PDUs having a level of importance that satisfies a predetermined threshold, and based on determining that the plurality of PUSCH transmissions is associated with one or more PDUs having a level of importance that satisfies a predetermined threshold, adjusting the common expiration point associated with (i) each of the one or more restarted configured grant timer and (ii) the remaining set of configured grant timers based on the time that the dynamic grant is received.

In some implementations, the importance of the PDU can include a severity level, a priority level, or a criticality level.

In some implementations, the dynamic grant is received before transmission of a plurality of PUSCH transmissions, during transmission of a plurality of PUSCH transmissions, or after transmission of a plurality of PUSCH transmissions.

According to another innovative aspect of the present disclosure, a method, to be performed by a UE, for restricting dynamic grant overruling of a configured grant in a PUSCH transmission cluster is disclosed. In one aspect, the method can include receiving a dynamic grant on PDCCH for the UE's C-RNTI that identifies a particular HARQ process of a plurality of HARQ processes associated with a plurality of PUSCH transmissions and seeks to overrule a configured grant for a particular PUSCH transmission of the plurality of PUSCH transmissions to which the particular HARQ process corresponds;, and prohibiting the dynamic grant from overruling the configured grant for a particular PUSCH transmission of the plurality of PUSCH transmissions to which the identified HARQ process corresponds.

Other aspects includes apparatuses, systems, and computer programs for performing the actions of the aforementioned method.

According to another innovative aspect of the present disclosure, a method, to be performed by a UE, for restricting dynamic grant overruling of a configured grant in a PUSCH transmission cluster is disclosed. In one aspect, the method can include receiving a dynamic grant on PDCCH for the UE's C-RNTI that identifies a particular HARQ process of a plurality of HARQ processes associated with a plurality of PUSCH transmissions and seeks to overrule a configured grant for a particular PUSCH transmission of the plurality of PUSCH transmissions to which the particular HARQ process corresponds, determining whether the particular PUSCH transmission to which the particular HARQ process identified by the dynamic grant corresponds is being used, and based on a determination that the particular PUSCH transmission to which the particular HARQ process identified by the dynamic grant corresponds is being used, prohibiting the dynamic grant from overruling the configured grant for a particular PUSCH transmission of the plurality of PUSCH transmissions to which the identified HARQ process corresponds.

Other aspects includes apparatuses, systems, and computer programs for performing the actions of the aforementioned method.

The innovative method can include other optional features. For example, in some implementations, the method can further include based on a determination that the particular PUSCH transmission to which the particular HARQ process identified by the dynamic grant corresponds is not being used: processing the dynamic grant received on PDCCH for the UE's C-RNTI that identifies the particular HARQ process of the plurality of HARQ processes associated with the plurality of PUSCH transmission and overrules the configured grant for the particular PUSCH transmission of the plurality of PUSCH transmissions to which the particular HARQ process corresponds.

### BRIEF DESCRIPTION OF THE DRAWINGS

FIG. 1 illustrates a wireless network, according to some implementations.

FIG. 2 illustrates a visualization of an uplink grant timer.

FIG. 3 illustrates a visualization of a PUSCH cluster used for transmission of a PDU set.

FIG. 4 illustrates a visualization of a PUSCH cluster applied in an uplink grant.

FIG. 5A illustrates a visualization of an example of a problem that arises when a dynamic grant overrules a configured grant of a PUSCH cluster.

FIG. 5B illustrates a visualization of an example of another problem that arises when a dynamic grant overrules a configured grant of a PUSCH cluster.

FIG. 6 illustrates a visualization of an example of a problem that arises when a dynamic grant overrules a configured grant of PUSCH cluster associated with a single CG timer for multiple HARQ processes.

FIG. 7 is a flowchart of an example of a process for adjusting a PUSCH cluster associated with a configured grant that has been overruled by a dynamic grant, in accordance with one aspect of the present disclosure.

FIG. 8 is a flowchart of an example of a process for setting a start point of an overruled CG timer value, in accordance with one aspect of the present disclosure.

FIG. 9 illustrates a visualization of an example of a process for setting a configured grant timer value for an implementation using multiple configured grant timers with a common expiry point.

FIG. 10 illustrates a visualization of another example of a process for setting a configured grant timer value for an implementation using multiple configured grant timers with a common expiry point.

FIG. 11 illustrates a visualization of another example of a process for setting a configured grant timer value for an implementation using multiple configured grant timers with a common expiry point.

FIG. 12 is a flowchart of a process for setting a configured grant timer value, for an implementation using multiple configured grant timers with a common expiry point.

FIG. 13 illustrates an example of a process for setting a configured grant timer value, for an implementation using a single configured grant timer for multiple HARQ processes.

FIG. 14 illustrates an example of another process for setting a configured grant timer value, for an implementation using a single configured grant timer for multiple HARQ processes.

FIG. 15 is a flowchart of a process for setting a configured grant timer value, for an implementation using a single configured grant timer for multiple HARQ processes.

FIG. 16 illustrates an example of a process for stopping one or more CG timers upon receipt of a HARCK-ACK for an implementation using multiple configured grant timers with a common expiry point.

FIG. 17 illustrates an example of an example of a process for stopping one or more CG timers upon receipt of a HARCK-ACK for an implementation using a single CG timer for multiple HARQ processes.

FIG. 18 illustrates an example of another example of a process for stopping one or more CG timers upon receipt of a HARCK-ACK for an implementation using a single CG timer for multiple HARQ processes.

FIG. 19 is a flowchart of an example of a process for setting a common expiration point for an implementation using multiple configured grant timers with a common expiry point.

FIG. 20 is a flowchart of an example of a process for restricting the overruling of a configured grant in a PUSCH cluster by a dynamic grant, in accordance with one aspect of the present disclosure.

FIG. 21 is a flowchart of another example of a process for restricting the overruling of a configured grant in a PUSCH cluster by a dynamic grant, in accordance with one aspect of the present disclosure.

FIG. 22 illustrates a user equipment (UE), according to some implementations.

FIG. 23 illustrates an access node, according to some implementations.

### DETAILED DESCRIPTION

The present disclosure is directed towards apparatus, systems, method, and computer programs for handling the overruling of a configured grant (CG) PUSCH transmission cluster by a dynamic grant (DG) or a DG-PUSCH transmission cluster. In some implementations, the UE can consider each combination of overruling DG and overruled CG based on the HARQ processes associated with each DG and CG. In such instances, a single DG or DG-PUSCH cluster may only restart selected CG timers, that is, CG timers with overlapping HARQ process IDs.

Alternatively, in other implementations, a whole CG-PUSCH cluster is invalidated (considered overruled). In such implementations, all CG timer(s) associated with the PUSCHs in the PUSCH cluster are restarted, for all respective HARQ processes. This option ensures a synchronized restart of the PUSCH cluster. When a CG-PUSCH cluster is treated as one compound unit, a single DG or a DG-PUSCH cluster may restart the single CG timer of the CG-PUSCH cluster-in this case, all CG-PUSCHs linked to the CG-PUSCH cluster are blocked.

When a CG-PUSCH cluster is treated as one compound unit, a single DG or DG-PUSCH cluster may restart all CG timers associated with the CG-PUSCH cluster-in this case, all CG-PUSCHs linked in the CG-PUSCH cluster are blocked

When the PUSCH duration of the DG is longer than the PUSCH duration of the CG PUSCH cluster, or the PUSCH duration of the DG spans over multiple CG-PUSCHs, then the following may apply. Specifically, regardless of the PUSCH duration, a single PUSCH occupies only one HARQ process. Therefore, this case can be considered as part of option A or B above.

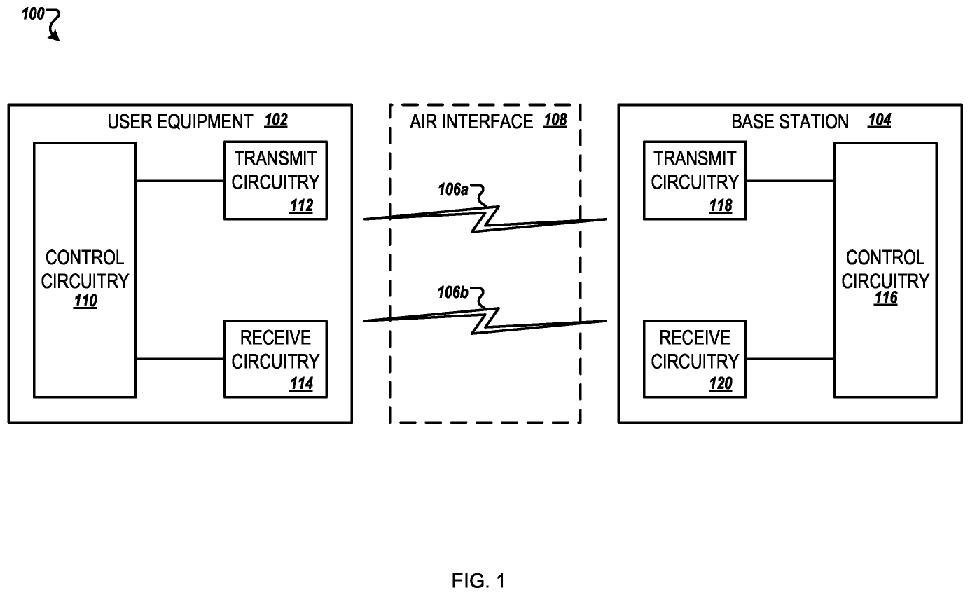

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

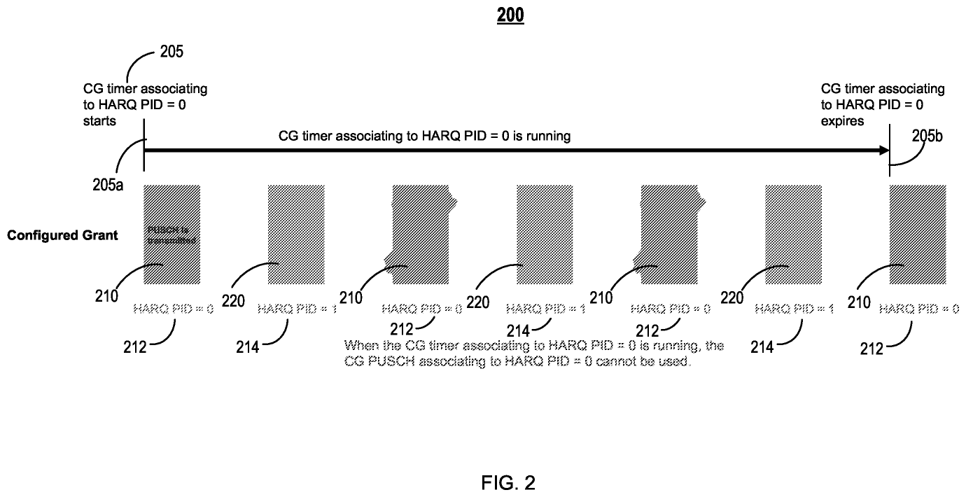

FIG. 2 illustrates a visualization 200 showing features of an uplink grant timer. As shown in FIGS. 2, 200, each PUSCH 210, 220 is associated with a hybrid automatic repeat request (HARQ) process ID 212, 214. A CG configuration may comprise multiple PUSCHs with the same HARQ process ID. The uplink grant timer could be any type of timer that may start with PUSCH transmission, such as a configured grant timer or a configured grant retransmission timer.

A configured grant (CG) timer 205 starts when a PUSCH 210 is transmitted (on the first orthogonal frequency division multiplexing (OFDM) symbol of the PUSCH). The configured grant timer 205 corresponds to the HARQ process 212 of the PUSCH 210. In the example of FIG. 2, the PUSCH 210 is a configured grant. However, the process is not so limited. Instead, the PUSCH may be a configured grant or a dynamic grant.

While the CG timer 205 associating to the HARQ process is running (e.g., from 205a to 205b), the UE shall not use CG resources with the same HARQ process. This is to avoid MAC PDU stored in the HARQ buffer being overwritten by new transmission, while the stored MAC PDU is still needed for HARQ retransmission.

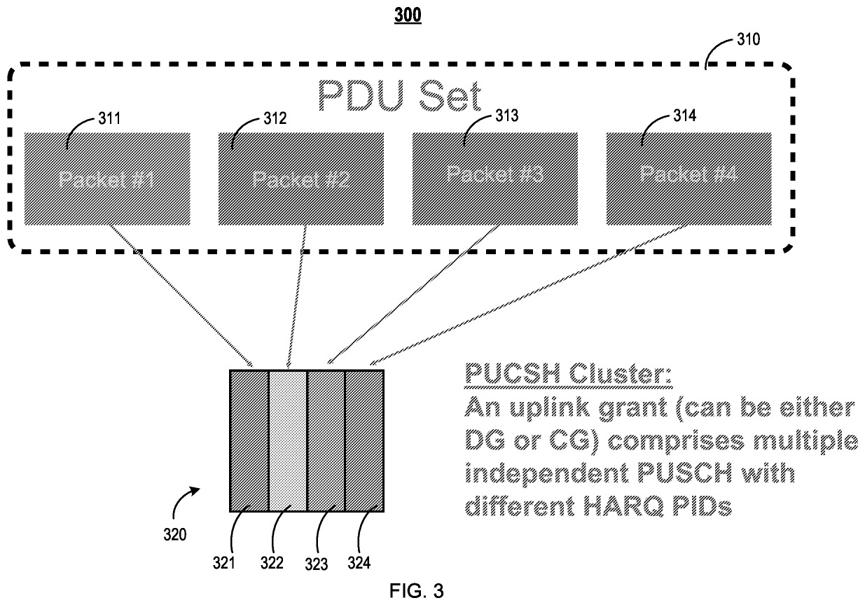

FIG. 3 illustrates a visualization 300 of a PUSCH cluster used for transmission of a PDU set. Certain services such as XR services can operate on a packet data unit (PDU) set 310 which comprises multiple packets 311 to 314 (e.g. IP packets), and each PDU Set 310 can be mapped to different QoS flows. All packets in a PDU set 310 should be delivered within the QoS requirement of a PDU Set Delay Budget (PSDB). When PSDB is exceeded and if any PDU of the PDU set is not yet successfully delivered, the whole PDU set may be discarded as it may not be useful to the application any more.

A PUSCH cluster 320 comprised of a plurality of PUSCH 321, 322, 323, 324 can be used to transmit a PDU set 310. In some implementations, for example, one PUSCH is used to convey one packet within the PDU set, as shown below. In such an example, PUSCH 321, is used to convey packet 311, PUSCH 322 is used to convey packet 312, PUSCH 323 is used to convey packet 313, and PUSCH 324 is used to convey packet 314. However, the present disclosure is not so limited. Instead, in some implementations, for example, multiple PUSCH may be needed convey a single packet. Likewise, in some implementations, a single PUSCH may include data from, for example, two different packets.

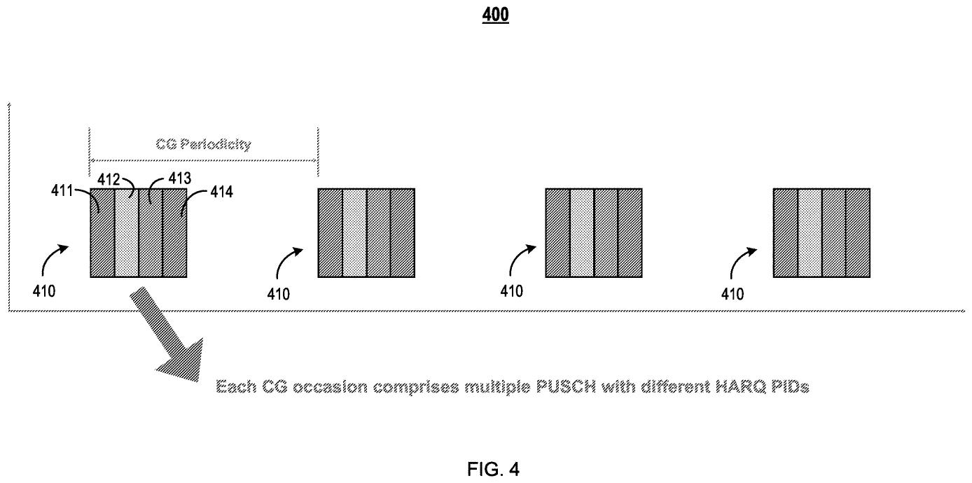

FIG. 4 illustrates a visualization 400 of a PUSCH cluster applied in a uplink grant. As described, an uplink grant may comprise a plurality of PUSCH, which may be referred to herein as a PUSCH cluster or a multi-PUSCH allocation as shown in FIG. 3. In addition, each PUSCH in the cluster can have a different HARQ process ID as shown in FIG. 2.

The example of FIG. 4 shows an example where PUSCH cluster is applied in a configured grant. However, the present disclosure is not so limited. Instead, PUSCH clusters can be applied in any uplink grant including a configured grant or a dynamic grant. However, in some implementations, regardless of whether the uplink grant is a configured grant or a dynamic grant, the uplink grant timer is grant timer is still any type of timer that may start with PUSCH transmission, such as a configured grant timer or a configured grant retransmission timer.

The configured grant with PUSCH cluster 410 can be cyclic or periodic as shown in FIG. 4. Each CG PUSCH cluster 410 occasion shown in FIG. 4 comprises multiple PUSCH 411, 412, 413, 414 with different HARQ PIDs. The configured grant with PUSCH cluster in each cycle can accommodate periodic traffic characteristics such as XR traffic characteristics including jitter and varying packet sizes. Jitter refers to late packet arrival, and since multiple PUSCH can be provisioned in each CG occasion with the PUSCH cluster, the UE does not need to wait until the next CG cycle to transmit this late packet. Varying packet size refers to when the packet size is too large, there will be sufficient resource in each CG occasion can still allow the whole packet to be transmitted on time.

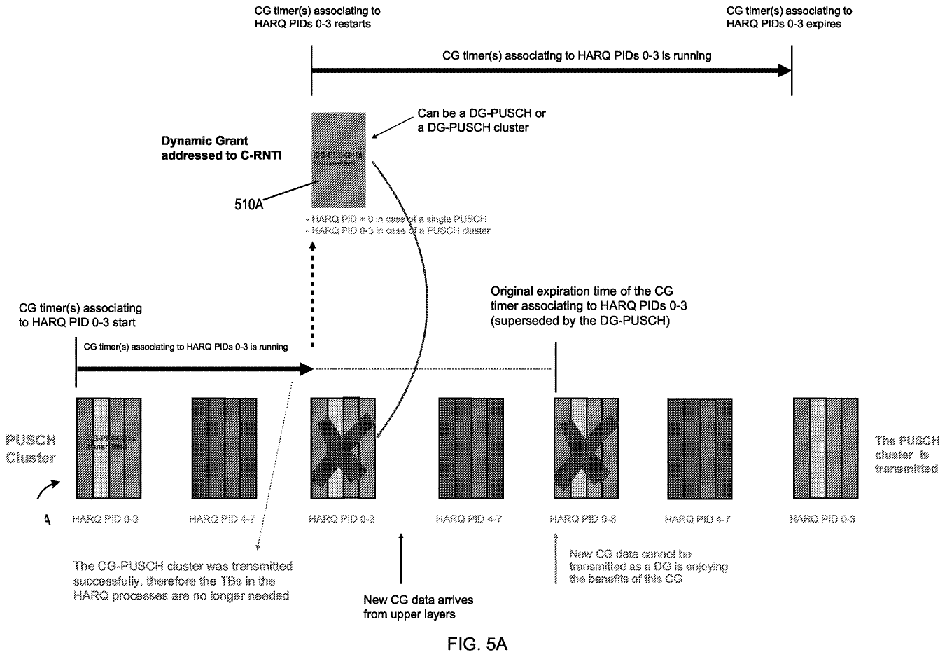

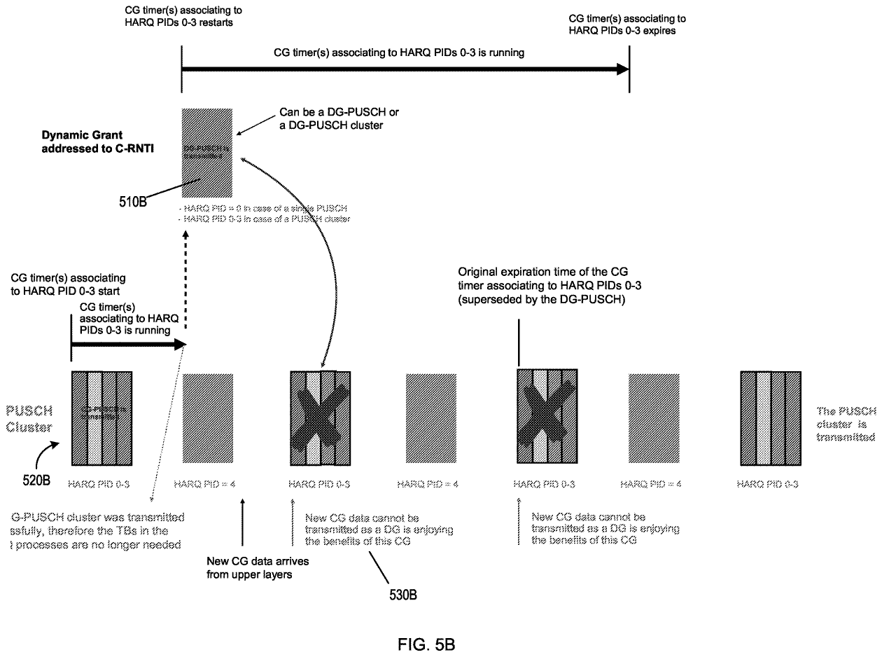

FIG. 5A illustrates a visualization of an example of a problem that arises when a dynamic grant overrules a configured grant of a PUSCH cluster. In FIG. 5A, the DG 510A unnecessarily blocks one or multiple HARQ processes of the PUSCH cluster 520A, even though the DG can retransmit using C-RNTI.

FIG. 5B illustrates a visualization of an example of another problem that arises when a dynamic grant overrules a configured grant of a PUSCH cluster. In FIG. 5B, the DG 510B arrives before the next occasion of the CG and blocks 530B the HARQ process for an even longer time.

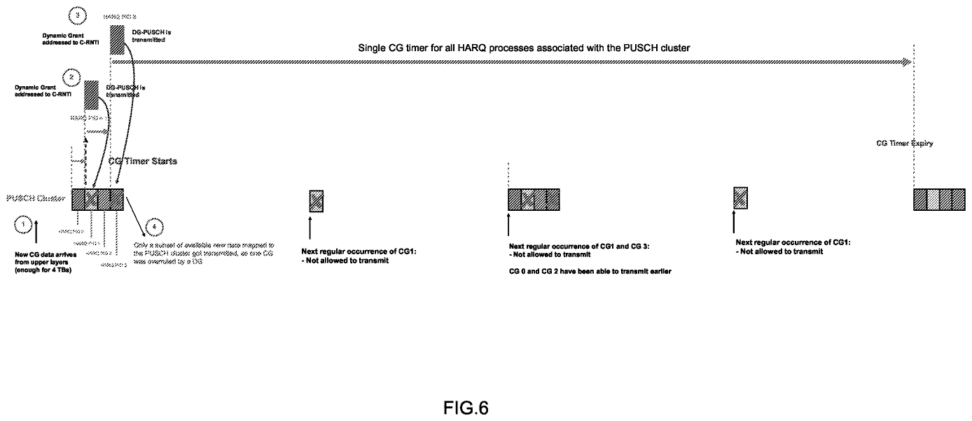

FIG. 6 illustrates a visualization of an example of a problem that arises when a dynamic grant overrules a configured grant of PUSCH cluster associated with a single CG timer for multiple HARQ processes. Apart from the present disclosure, no solutions have been developed to handle in detail a scenario depicted in FIG. 6 has not been considered earlier.

This is regardless of whether a single CG timer is used for all HARQ processes in the PUSCH cluster or whether multiple CG timers are used with a common expiry point

The figure below already includes half a solution (restarting the single CG timer multiple times, updating association of HARQ processes with the PUSCH cluster)

### Changing an Association of an Overruled CG With a PUSCH Cluster

In some implementations, when a DG overrules a CG that is part of a PUSCH cluster the association of the overruled CG with the PUSCH cluster may change. The association between the overruled CG and the PUSCH cluster may be changed in a number of different ways.

In some implementations, for example, the CG may be considered as temporarily removed from the PUSCH cluster for as long as its HARQ process is overruled by a DG. In some implementations, the CG may be considered as temporarily removed from the PUSCH cluster until its CG timer stops or expires, following the overrule event. In some implementations, the overruled CG may automatically rejoin the PUSCH cluster afterwards (once the overrule ceases). In some implementations, the overruled CG may remain associated to the PUSCH cluster during the overrule period, but its HARQ process is no longer protected by the single common CG timer.

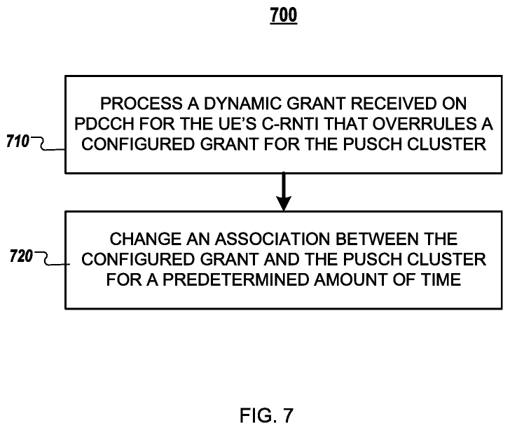

FIG. 7 is a flowchart of an example of a process 700 for adjusting a PUSCH cluster associated with a configured grant that has been overruled by a dynamic grant, in accordance with one aspect of the present disclosure. The process 700 will described as being performed by user equipment (UE) such as the UE 102 or the UE 2200.

A UE can begin execution of the process 700 by processing a dynamic grant received on PDCCH for the UE's C-RNTI that overrules a configured grant for the PUSCH cluster (710).

The UE can continue execution of the process 700 by changing an association between the configured grant and the PUSCH cluster for a predetermined amount of time (720). In some implementations, execution of the changing stage at 720, by the UE, can include the UE removing the association of the configured grant with the PUSCH cluster while the dynamic grant overrules the configured grant. In some implementations, execution of the changing stage 720, by the UE, can include the UE removing the association of the configured grant with the PUSCH cluster until a configured grant timer associated with the configured grant expires. In some implementations, execution of the changing stage at 720, by the UE, can include the UE enabling a HARQ process of the PUSCH cluster that is associated with the configured grant to be overwritten while the dynamic grant overrules the configured grant.

### Setting of a Starting Point of an Overruled CG Timer Value

In some implementations, the starting point of the overruled CG timer value may follow the starting point of the CG timer of the PUSCH cluster. If the CG timer(s) of the PUSCH cluster start(s) in any first OFDM symbol of the cluster, then the overruled CG timer also starts in the first OFDM symbol. Alternatively, if the CG timer(s) of the PUSCH cluster start(s) after any last OFDM symbol of the cluster, then the overruled CG timer also starts after the last OFDM symbol.

However, if the starting points of the CG timers are not following this rule (i.e. their starting points are not matched), then an additional offset needs to be considered to account for the length of the respective first/last OFDM symbol starting the timer (or it can be part of a general offset). In some implementations, the offset can be negative.

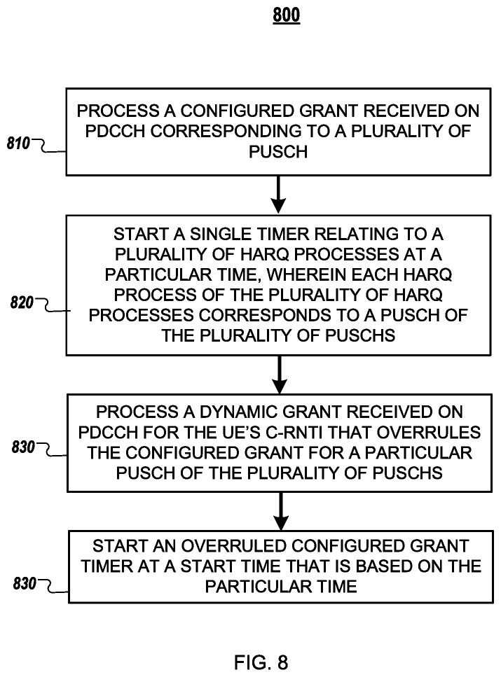

FIG. 8 is a flowchart of an example of a process 800 for setting a start point of an overruled CG timer value, in accordance with one aspect of the present disclosure. The process 800 will described as being performed by user equipment (UE) such as the UE 102 or the UE 2200.

A UE can begin execution of a process 800 by processing a configured grant received on PDCCH corresponding to a plurality of PUSCH (810).

The UE can continue execution of the process 800 by starting a single timer relating to a plurality of HARQ processes at a particular time, wherein each HARQ process of the plurality of HARQ processes corresponds to a PUSCH of the plurality of PUSCHs (820).

The UE can continue execution of the process 800 by processing a dynamic grant received on PDCCH for the UE's C-RNTI that overrules the configured grant for a particular PUSCH the plurality of PUSCHs (830).

The UE can continue execution of the process 800 by starting an overruled configured grant timer at a start time that is based on the particular time (840). In some implementations, the particular time that the single timer starts corresponds to: is (i) at a beginning of a first PUSCH of the plurality of PUSCH, or (ii) after a termination of a last PUSCH of the plurality of PUSCH. In such implementations, execution of the starting stage at 840, by the UE, can include starting the overruled configured grant timer at the same time as the particular time that the single timer relating to a plurality of HARQ processes is started. Alternatively, in some implementations, the particular time that the single timer starts corresponds to a time that is different than (i) at a beginning of a first PUSCH of the plurality of PUSCH, or (ii) after a termination of a last PUSCH of the plurality of PUSCH. In such implementations, execution of the starting stage at 840, by the UE, can include the UE starting the overruled configured grant timer at a time that is a function of the particular time that the single timer relating to a plurality of HARQ processes is started and an offset. In some implementations, the offset accounts for a length from the beginning of the first PUSCH or a termination of the last PUSCH. In some implementations, the offset is a predetermined length. In some implementations, the offset is negative.

In some implementations, the UE can continue execution of the process 800 by refraining from performing a new transmission on one or more configured grant resources associated with one or more of the plurality of HARQ processes when the single timer is running. In some implementations, refraining from performing a new transmission on one or more configured grants associated with a HARQ process that is associated with the particular PUSCH when the overruled configured grant timer is running.

### Setting a Timer Value of a CG Timer Associated With a HARQ Process Identified by an Overruling Dynamic Grant—Common Expiry Time for Multiple CG Timers

In some implementations, upon reception of an uplink grant for the MAC entity's C-RNTI, if the identified HARQ process is configured for a configured uplink grant associated with a PUSCH cluster, the CG timer associated with the HARQ process is restarted using one or more timer values value.

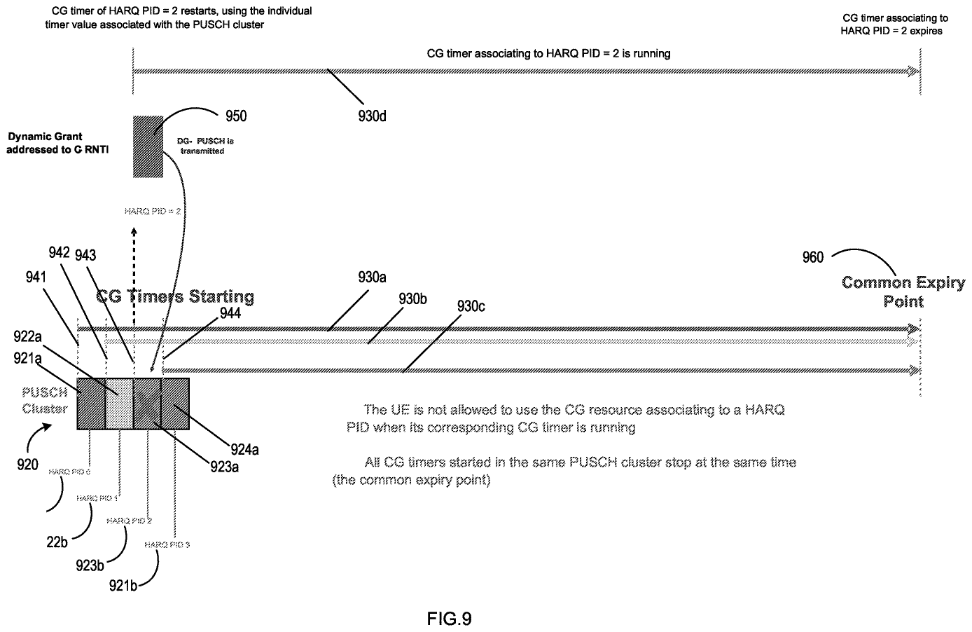

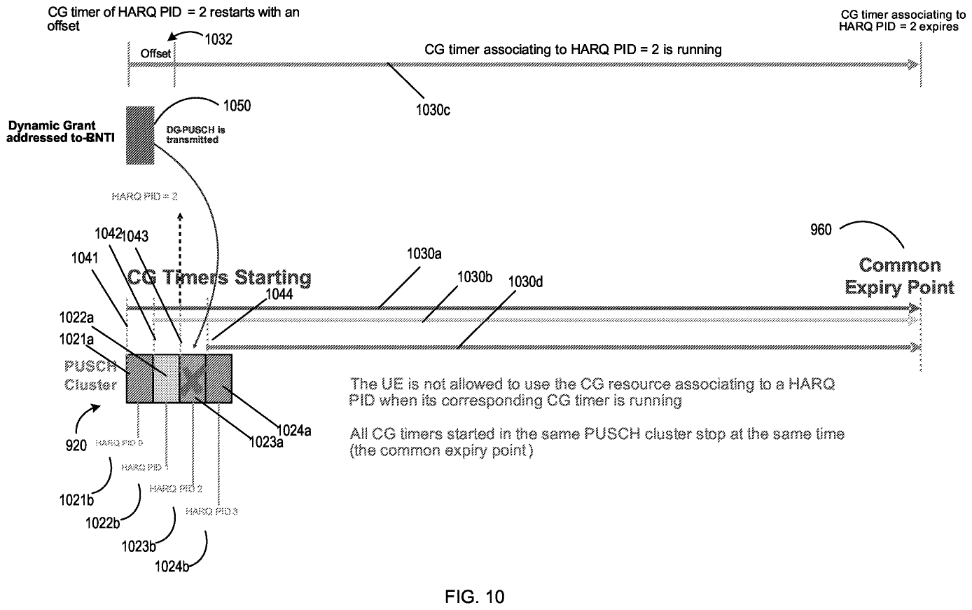

In some implementations, for example, A UE can use the current value of a CG timer that is leading up to the common expiry point. In other words the CG timer restarts using the CG's (individual) timer value associated with the PUSCH cluster, so that it expires at the common expiry point. In some implementations, the overruling DG would occur at the same time with the CG (see, e.g., FIG. 9). If the overruling DG occurs slightly earlier than the CG (as in FIG. 10) the time distance between DG and CG needs to be considered as part of the CG timer value, for example, as an offset. If the overruling DG occurs slightly after the CG but before the next common expiry point, the offset may be negative. In some implementations, the offset may be large enough to hit the next common expiry point. In some implementations, the overruling DG may provide an offset to the CG timer value (or the timer value to be used) on the DCI

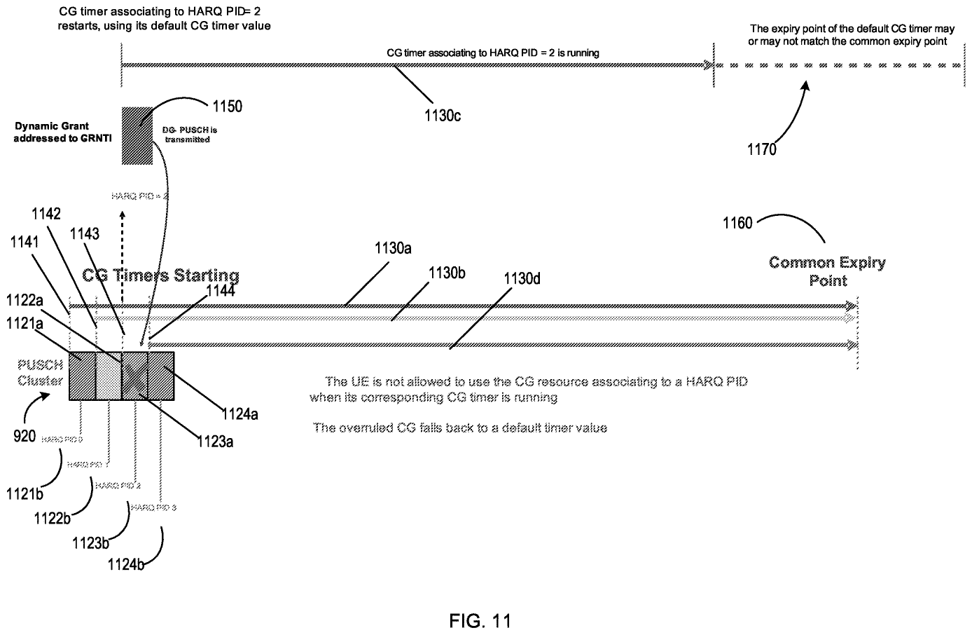

In some implementations, a UE can use a (separate) timer value based on the regular configuration of the CG. For example, the CG may have an individual (default) config when acting as an individual CG and a common (or group) config when acting as part of a PUSCH cluster. This means the CG timer may not expire at the common expiry point. Such an example is illustrated in FIG. 11.

FIG. 9 illustrates a visualization 900 of an example of a process for setting a configured grant timer value for an implementation using multiple configured grant timers 930a, 930b, 930c, 930d with a common expiry point 960. In the example of FIG. 9, each of the multiple configured grant timers 930a, 930b, 930c, 930d relate to one of the respective HARQ processes 921b, 922b, 923b, 923b associated with the PUSCH cluster 920 comprising a plurality of PUSCH 921a, 922a, 923a, 924a. Each of the multiple configured grant timers 930a, 930b, 930c, 930d have a different respective starting point 941, 942, 943, 944, respectively, but a common expiration point 960. In this example of FIG. 9, a dynamic grant 950 is received on PDCCH for the UE's C-RNTI that identifies a particular HARQ process HARQ PID 2 and overrules the configured grant for PUSCH 923a of the PUSCH cluster 920. Then, the CG timer 930c of HARQ PID=2 restarts, using the individual timer value associated with the PUSCH cluster 923a and continues to run until the common expiry point 960. The UE is not allowed to use CG resources associating to a HARQ PID when its corresponding CG timer is running.

FIG. 10 illustrates a visualization 1000 of another example of a process for setting a configured grant timer value for an implementation using multiple configured grant timers 1030a, 1030b, 1030c, 1030d with a common expiry point 1060. In the example of FIG. 10, each of the multiple configured grant timers 1030a, 1030b, 1030c, 1030d relate to one of the respective HARQ processes 1021b, 1022b, 1023b, 1024b associated with the PUSCH cluster 1020 comprising a plurality of PUSCH 1021a, 1022a, 1023a, 1024a. Each of the multiple configured grant timers 1030a, 1030b, 1030c, 1030d have a different respective starting point 1041, 1042, 1043, 1044, respectively, but a common expiration point 1060. In this example of FIG. 10, a dynamic grant 1050 is received on PDCCH for the UE's C-RNTI that identifies a particular HARQ process HARQ PID 2, but arrives slightly earlier than the CG corresponding to PUSCH 1023a. The dynamic grant 1050 overrules the configured grant for PUSCH 1023a of the PUSCH cluster 920. Then, the CG timer 1030c of HARQ PID=2 restarts with an offset 1032, using the individual timer value associated with the PUSCH cluster 1023a plus the additional offset 1032 because the dynamic grant 1050 arrived before the CG corresponding to PUSCH 1023a. The CG timer 1030c of HARQ PID=2 continues to run until the common expiry point 1060. The UE is not allowed to use CG resources associating to a HARQ PID when its corresponding CG timer is running.

FIG. 11 illustrates a visualization 1100 of another example of a process for setting a configured grant timer value for an implementation using multiple configured grant timers 1130a, 1130b, 1130c, 1130d with a common expiry point 1160. In the example of FIG. 11, each of the multiple configured grant timers 1130a, 1130b, 1130c, 1130d relate to one of the respective HARQ processes 1121b, 1122b, 1123b, 1124b associated with the PUSCH cluster 1120 comprising a plurality of PUSCH 1121a, 1122a, 1123a, 1124a. Each of the multiple configured grant timers 1130a, 1130b, 1130c, 1130d have a different respective starting point 1141, 1142, 1143, 1144, respectively, but a common expiration point 1160. In this example of FIG. 11, a dynamic grant 1150 is received on PDCCH for the UE's C-RNTI that identifies a particular HARQ process HARQ PID 2 and overrules the configured grant for PUSCH 1123a of the PUSCH cluster 1120. In this example, which differs from the similar example of FIG. 9, the CG timer 1130c associating to HARQ PID=2 restarts, using a default CG timer value. Because a default timer value is used to set the timer value of the CG timer 1130c, the expiry point of CG timer 1130c may or may not match the common expiry point 1160. The UE is not allowed to use CG resources associating to a HARQ PID when its corresponding CG timer is running.

However, depending on the scenario and the timer value utilizing the default CG timer value described with respect to FIG. 11 may lead to suboptimal usage of resources relative to the examples of FIGS. 9 and 10, as the HARQ process may be overwritten by another TB or the HARQ process may be blocked even in the next PUSCH cluster.

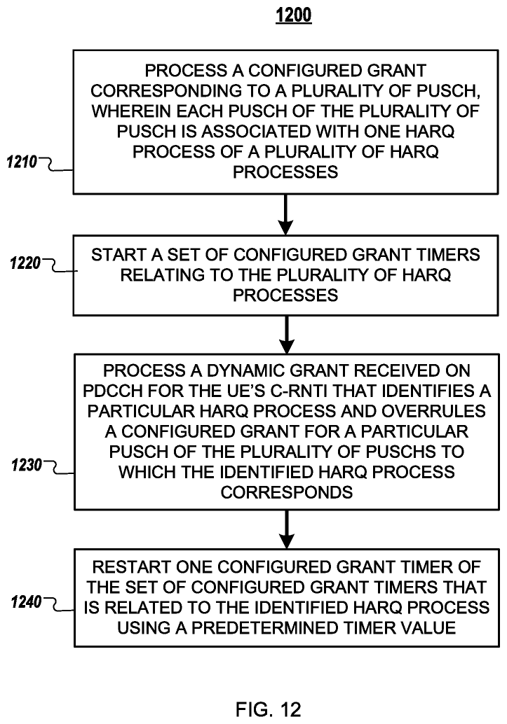

FIG. 12 is a flowchart of a process 1200 for setting a configured grant timer value, for an implementation using multiple configured grant timers with a common expiry point. The process 1200 will described as being performed by user equipment (UE) such as the UE 102 or the UE 2200.

A UE can begin execution of the process 1200 by processing, a configured grant corresponding to a plurality of PUSCH, wherein each PUSCH of the plurality of PUSCH is associated with one HARQ process of a plurality of HARQ processes (1210).

The UE can continue execution of the process 1200 by starting a set of configured grant timers relating to the plurality of HARQ processes (1220).

The UE can continue execution of the process 1200 by processing a dynamic grant received on PDCCH for the UE's C-RNTI that identifies a particular HARQ process and overrules a configured grant for a particular PUSCH of the plurality of PUSCHs to which the identified HARQ process corresponds (1230).

The UE can continue execution of the process 1200 by restarting one configured grant timer of the set of configured grant timers that is related to the identified HARQ process using a predetermined timer value (1240). In some implementations, the predetermined timer value is a remainder of an initial duration of the configured grant timer related to the identified HARQ process that causes the configured grant timer related to the particular HARQ process to expire at a common expiry point established for one or more other HARQ processes corresponding to another respective PUSCH of the plurality of PUSCHs.

In some implementations, execution of the process 1200, by the UE, can include the UE refraining from performing a new transmission on one or more configured grants associated with the identified HARQ process that is associated with the particular PUSCH when the restarted configured grant timer is running.

In some implementations, execution of the process 1200, by the UE, can include the UE determining that the overruling dynamic grant does not occur at the same periodic time as the configured grant. In such implementations, execution of the process 1200, by the UE, can include the UE adjusting the predetermined timer value by an offset. In some UE's determination that the overruling dynamic grant does not occur at the same periodic time as the configured grant can include the UE determining that the overruling dynamic grant occurs after the configured grant by before a common expiration point for the set of configured grant timers. In such a scenario where the overruling dynamic grant occurs after the configured grant, but before a common expiration point for the set of configured grant timers, the UE can adjust the predetermined timer value by a negative offset.

In some implementations, the dynamic grant received via PDCCH include the offset. In some implementations, the predetermined timer value is based on a default timer value associated with the configured grant timer.

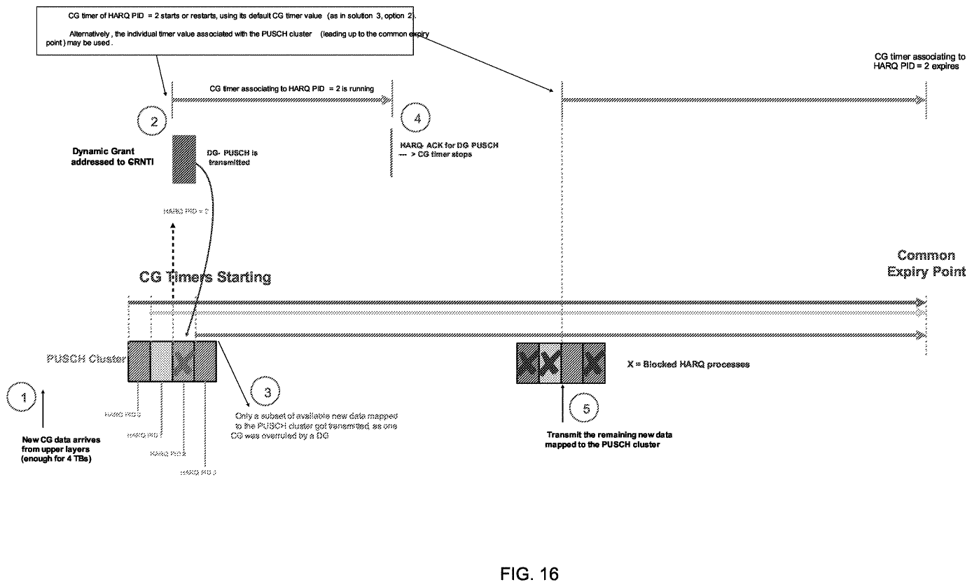

In some implementations, the UE can continue execution of a receiving a HARQ-ACK for the particular HARQ process identified by the dynamic grant. In such implementations, the UE can stop the configured grant timer related to the identified HARQ process. This process for stopping a HARQ-ACK early is shown in more detail in FIG. 16 for multiple configured grant timers having a common expiry point.

### Setting a Timer Value of a CG Timer Associated With a HARQ Process Identified by an Overruling Dynamic Grant—Single Configured Grant Timer for Multiple HARQ Processes

In some implementations, such as for the case of a single CG Timer for Multiple HARQ Processes, a UE can set the value of the CG timer in a number of different ways.

In some implementations, for example, the overruled HARQ process suspends its association with the single CG timer. Instead, the HARQ process is protected by an individual CG timer, and its timer value may be set based on: (a) the default CG timer value (similar to the example of FIG. 11 above), or (b) the common CG timer value of the single CG timer associated with the PUSCH cluster.

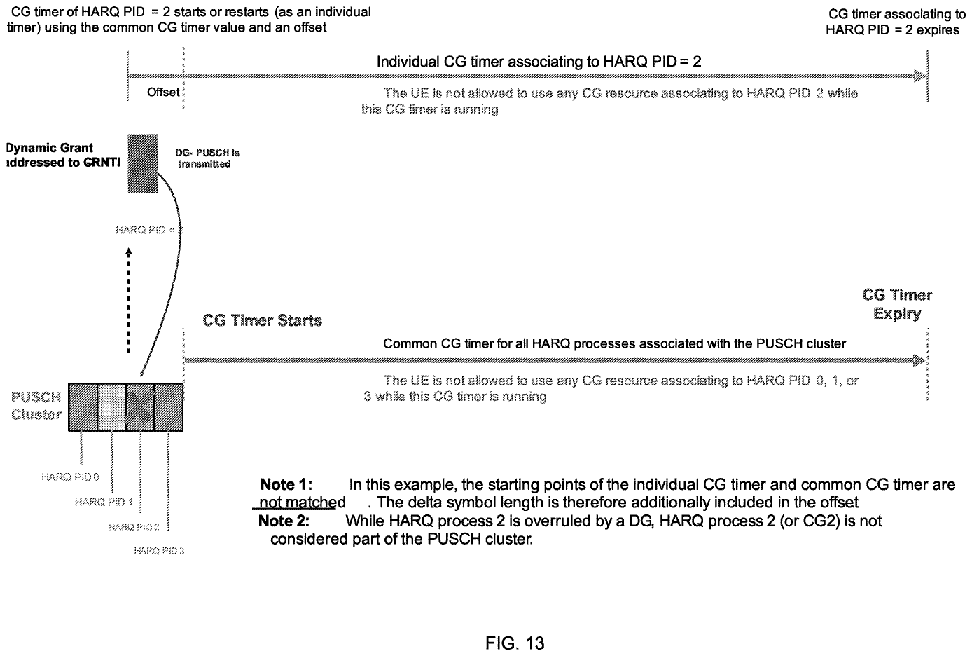

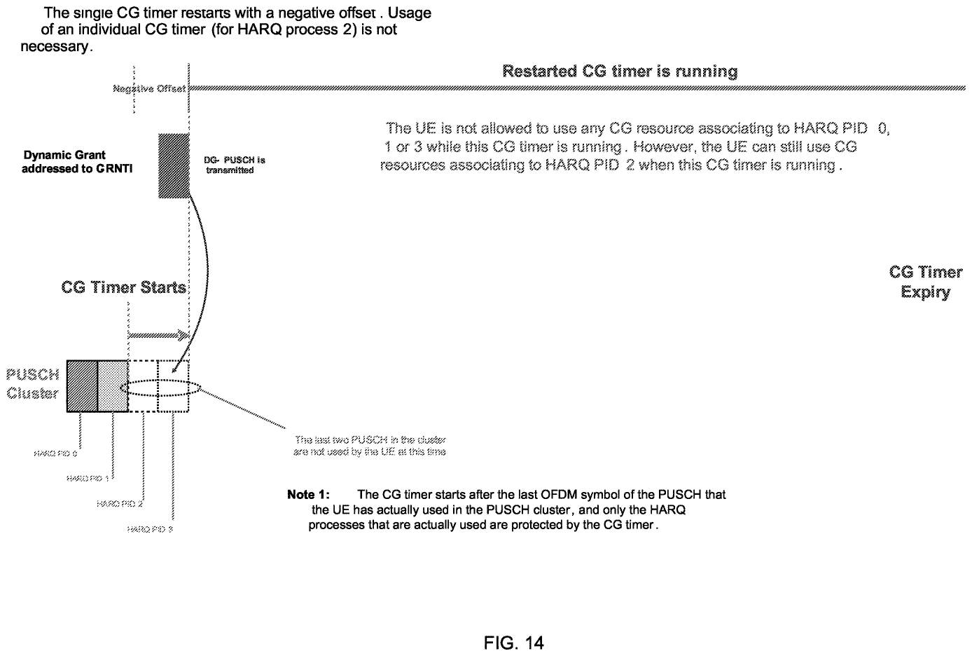

In some implementations, a single CG timer is used for multiple HARQ processes, but upon DG overruling the CG the association of the HARQ processes is updated. Depending on the time point of the timer restart, a positive or negative offset may be applied on top of the regular timer value. An example of a positive offset is applied in FIG. 13, whereas an example of negative offsets are shown in FIG. 14.

FIG. 13 illustrates an example of a process for setting a configured grant timer value, for an implementation using a single configured grant timer for multiple HARQ processes. FIG. 14 illustrates an example of another process for setting a configured grant timer value, for an implementation using a single configured grant timer for multiple HARQ processes.

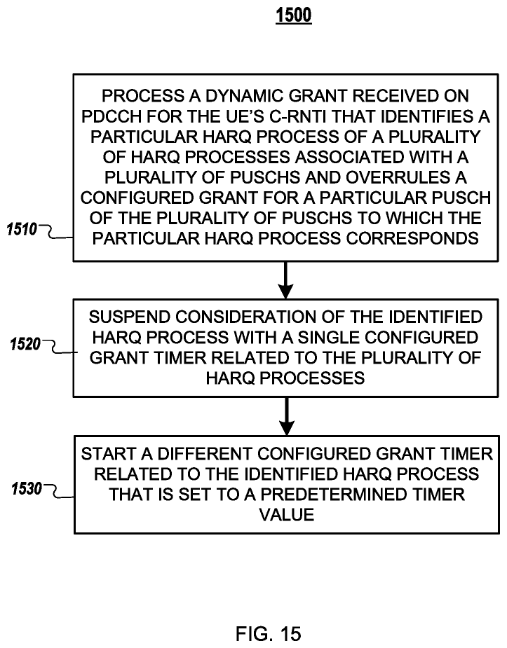

FIG. 15 is a flowchart of a process 1500 for setting a configured grant timer value, for an implementation using a single configured grant timer for multiple HARQ processes. The process 1500 will described as being performed by user equipment (UE) such as the UE 102 or the UE 2200.

A UE can begin execution of the process 1500 by processing a dynamic grant received on PDCCH for the UE's C-RNTI that identifies a particular HARQ process of a plurality of HARQ processes associated with a plurality of PUSCHs and overrules a configured grant for a particular PUSCH of the plurality of PUSCHs to which the particular HARQ process corresponds (1510).

The UE can continue execution of the process 1500 by suspending consideration of the identified HARQ process with a single configured grant timer related to the plurality of HARQ processes (1520).

The UE can continue execution of the process 1500 by starting a different configured grant timer related to the identified HARQ process that is set to a predetermined timer value (1530). In some implementations, the predetermined timer value is based on a default timer value. wherein the predetermined timer value is based on the single configured grant timer related to the plurality of HARQ processes. In some implementations, the predetermined timer value is based on the single configured grant timer related to the plurality of HARQ processes and an offset.

In some implementations, execution of the process 1500 can include the UE determining that the overruling dynamic grant occurs after the configured grant and before expiry of the single configured grant timer. In such implementations, the UE can continue execution of the process 1500 by setting the offset to a negative offset.

In some implementations, execution of the process 1500 can include refraining from performing a new transmission on one or more configured grants associated with the identified HARQ process that is associated with the particular PUSCH when the different configured grant timer is running.

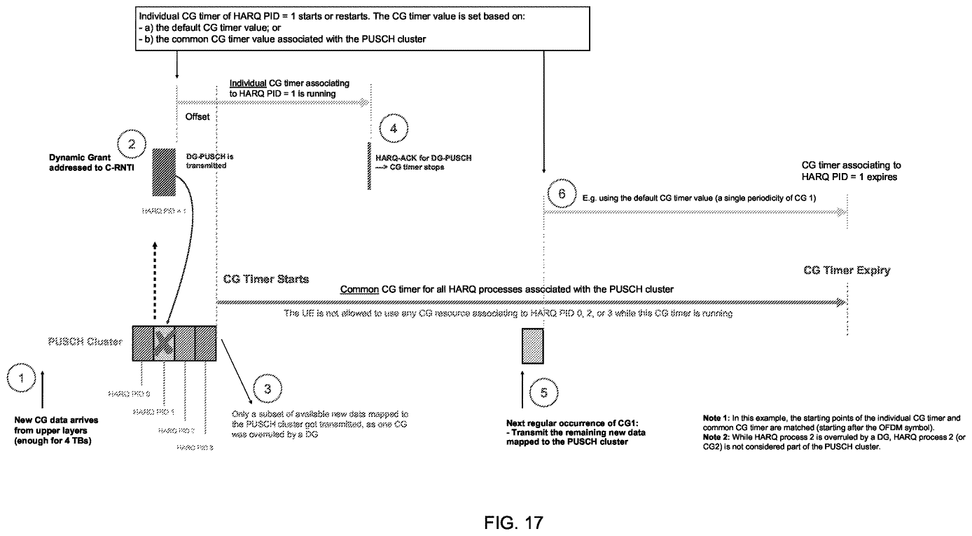

In some implementation, execution of the process 1500 can include receiving a HARQ-ACK for the particular HARQ process identified by the dynamic grant. In such implementations, the UE can continue execution of the process 1500 by stopping the different configured grant timer related to the identified HARQ process. This process for stopping a HARQ-ACK early is shown in more detail in FIG. 17 for a single configured grant timer.

### Stopping or not Starting the CG Timer

Upon reception of an uplink grant for the MAC entity's C-RNTI, if the identified HARQ process is configured for a configured uplink grant associated with a PUSCH cluster, the CG timer associated with the HARQ process is restarted. The timer may be stopped upon reception of HARQ-ACK for the overruling DG (assuming the next DG is not conditioned to overrule the CG again). Likewise the CG timer may not start again, if the next DG (for the same HARQ process) is not eligible to be used according to the LCP mapping restrictions, or does not have data available to be multiplexed. This solution allows to relinquish the HARQ process (for a PUSCH cluster) from the protection to enable continuing the transmitting other data as early as possible

The CG timer intended to stop upon HARQ-ACK (and/or not start again) can be an individual CG timer or the common single CG timer. If the overruled CG is associated with an individual CG timer, stop the individual timer. If the overruled CG is associated with a single timer, stop the single timer. Examples of solutions for stopping a CG timer upon receipt of a HARQ-ACK are set forth in FIGS. 16-18.

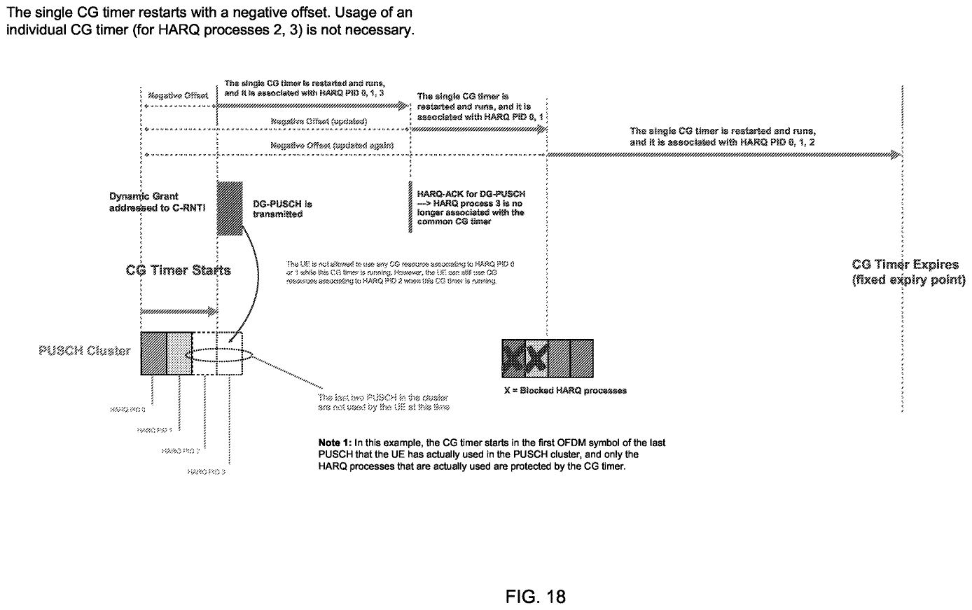

FIG. 16 illustrates an example of a process for stopping one or more CG timers upon receipt of a HARCK-ACK for an implementation using multiple configured grant timers with a common expiry point. FIG. 17 illustrates an example of an example of a process for stopping one or more CG timers upon receipt of a HARCK-ACK for an implementation using a single CG timer for multiple HARQ processes. FIG. 18 illustrates an example of another example of a process for stopping one or more CG timers upon receipt of a HARCK-ACK for an implementation using a single CG timer for multiple HARQ processes.

### Setting of Common Expiry Points for Multiple Configured Grant Timers

Upon reception of an uplink grant for the MAC entity's C-RNTI, if the identified HARQ process is configured for a configured uplink grant associated with a PUSCH cluster, the CG timer associated with the HARQ process is restarted. Overall all PUSCHs in the PUSCH cluster are protected until a certain point in time (dubbed the ‘expiry point’), wherein either multiple CG timers expire at a common expiry point or a single CG timer (associated with multiple HARQ processes) expires.

If a DG overrules a CG in a PUSCH cluster, the expiry point of CG timers in the PUSCH cluster may be modified in a number of different ways. In some implementations, for example, the expiry point of the CG timer(s) in a PUSCH cluster can remain unchanged. Such an implementations may be beneficial when, for example, accommodating a common PDU Set Delay Budget (PSDB) for the multiple PUSCHs in the cluster.

In some implementations, the expiry point of the CG timer(s) in a PUSCH cluster is modified/adjusted. For example, in some implementations, the expiry point of the CG timer(s) in a PUSCH cluster is modified/adjusted, but it is only done so if multiple CGs in the PUSCH cluster are overruled by a DG (or multiple DGs). In other implementations, the expiry point of the CG timer(s) in a PUSCH cluster is modified/adjusted, but it is only done so if the PUSCH cluster is associated with PDUs of different severity, priority or importance, or if critical data cannot be transmitted due to the DGs overruling.

In any of these scenarios where the expiry point is adjusted, when the expiry point can be adjusted, it may be updated based on the time when the overruling DG is received (for example, before, during, or after transmission of the PUSCH cluster).

The value of the adjustment may depend on the availability of other (alternative) PUSCH transmit occasions leading up to the expiry point in the PUSCH cluster (e.g., whether periods with multiple periodicities are utilized).

An adjustment of the expiry point may also depend on whether or not the PSDB is allowed to be extended, or whether enough headroom for additional transmissions exists.

A number of different expiry point options can be used to modify, or otherwise set, the expiry point. For example, in some implementations, (i) the expiry point remains unchanged, (ii) the expiry point may shift left, to an earlier point in time (e.g., by an offset), (iii) the expiry point may shift right, to a later point in time (e.g., by an offset), (iv) the expiry point (i.e. the delta) may be determined by one or multiple periodicities of the CGs associated with the PUSCH cluster, (v) he expiry point (i.e. the delta) may be determined based on when (and/or whether) a HARQ-ACK was received for the overruling DG, (vi) the expiry point may shift to the next periodicity of the PUSCH cluster/the next expiry point, or (vii) the overruling DG may provide a rule on the DCI as to how the expiry point is to be updated and/or how the final result is to be derived.

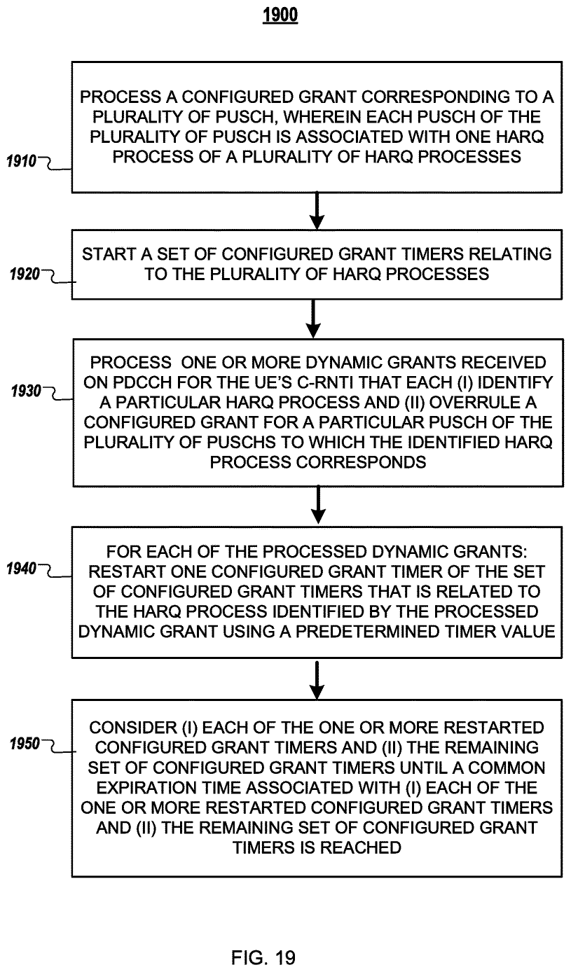

FIG. 19 is a flowchart of an example of a process 1900 for setting a common expiration point for an implementation using multiple configured grant timers with a common expiry point. The process 1900 will described as being performed by user equipment (UE) such as the UE 102 or the UE 2200.

A UE can begin execution of the process 1900 by processing a configured grant corresponding to a plurality of PUSCH, wherein each PUSCH of the plurality of PUSCH is associated with one HARQ process of a plurality of HARQ processes (1910).

A UE can continue execution of the process 1900 by starting a set of configured grant timers relating to the plurality of HARQ processes (1920).

A UE can continue execution of the process 1900 by processing one or more dynamic grants received on PDCCH for the UE's C-RNTI that each (i) identify a particular HARQ process and (ii) overrule a configured grant for a particular PUSCH of the plurality of PUSCHs to which the identified HARQ process corresponds (1930).

Then, for each of the processed dynamic grants, the UE can continue execution of the process 1900 by restarting one configured grant timer of the set of configured grant timers that is related to the HARQ process identified by the processed dynamic grant using a predetermined timer value (1940).

The UE can continue execution of the process 1900 by considering, by the UE, (i) each of the one or more restarted configured grant timers and (ii) the remaining set of configured grant timers until a common expiration point associated with (i) each of the one or more restarted configured grant timer and (ii) the remaining set of configured grant timers is reached (1950). In some implementations, the UE can stop the set of timers at the common expiration point.

In some implementations, execution of the process 1900 can include determining that multiple dynamic grants have been processed. Then, based on a determination that multiple dynamic grants have been processed, the UE can continue execution of the process 1900 by adjusting the common expiration point associated with (i) each of the one or more restarted configured grant timer and (ii) the remaining set of configured grant timers.

In some implementations, the UE can continue execution of the process 1900 by determining that the plurality of PUSCH is associated with one or more PDUs having a level of importance that satisfies a predetermined threshold. Then, based on determination that the plurality of PUSCH is associated with one or more PDUs having a level of importance that satisfies a predetermined threshold, the UE can continue execution of the process 1900 by adjusting the common expiration point associated with (i) each of the one or more restarted configured grant timer and (ii) the remaining set of configured grant timers based on the time that the dynamic grant is received. In some implementations, the importance of the PDU can include a severity level, a priority level, or a criticality level.

In some implementations, a dynamic grant can be received before transmission of a plurality of PUSCH, during transmission of a plurality of PUSCH, or after transmission of a plurality of PUSCH.

### Restrictions on Overruling of Configured Grant in PUSCH Cluster by Dynamic Grant

In some implementations, the overruling of a CG in a PUSCH cluster may not be supported. In order to reduce the number of corner cases to be considered, a DG may not be allowed to overrule a CG belonging to a PUSCH cluster. The specification may contain a restriction by explicitly disallowing the case in the MAC or RRC specification. The restriction may be of general nature (the DG overrule of a PUSCH cluster is not allowed at all) or bound to a specific scenario, which can be defined in or associated with a configuration.

Alternatively, a DG may be allowed to overrule a CG belonging to a PUSCH cluster if and only if the PUSCH in the PUSCH cluster is not used.

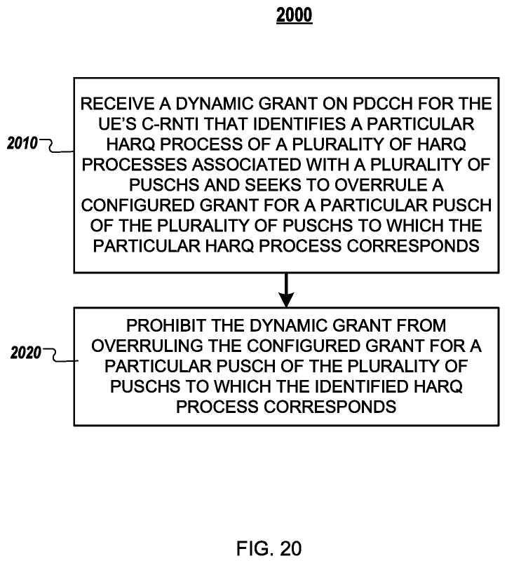

FIG. 20 is a flowchart of an example of a process 2000 for restricting the overruling of a configured grant in a PUSCH cluster by a dynamic grant, in accordance with one aspect of the present disclosure. The process 2000 will described as being performed by user equipment (UE) such as the UE 102 or the UE 2200.

A UE can begin execution of the process 2000 by receiving a dynamic grant on PDCCH for the UE's C-RNTI that identifies a particular HARQ process of a plurality of HARQ processes associated with a plurality of PUSCHs and seeks to overrule a configured grant for a particular PUSCH of the plurality of PUSCHs to which the particular HARQ process corresponds (2010).

The UE can continue execution of the process 2000 by prohibiting the dynamic grant from overruling the configured grant for a particular PUSCH of the plurality of PUSCHs to which the identified HARQ process corresponds (2020).

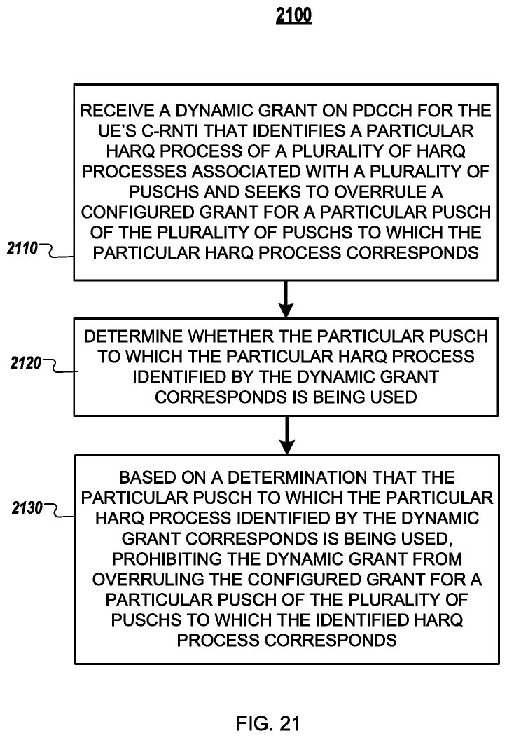

FIG. 21 is a flowchart of another example of a process 2100 for restricting the overruling of a configured grant in a PUSCH cluster by a dynamic grant, in accordance with one aspect of the present disclosure. The process 2100 will described as being performed by user equipment (UE) such as the UE 102 or the UE 2200.

A UE can begin execution of a process 2100 by receiving a dynamic grant on PDCCH for the UE's C-RNTI that identifies a particular HARQ process of a plurality of HARQ processes associated with a plurality of PUSCHs and seeks to overrule a configured grant for a particular PUSCH of the plurality of PUSCHs to which the particular HARQ process corresponds (2110).

The UE can continue execution of the process 2011 by determining whether the particular PUSCH to which the particular HARQ process identified by the dynamic grant corresponds is being used (2120).

Then, based on a determination, by the UE, that the particular PUSCH to which the particular HARQ process identified by the dynamic grant corresponds is being used, the UE can continue execution of the process 2100 by prohibiting the dynamic grant from overruling the configured grant for a particular PUSCH of the plurality of PUSCHs to which the identified HARQ process corresponds (2130).

Alternatively, in some implementations, based on a determination that the particular PUSCH to which the particular HARQ process identified by the dynamic grant corresponds is not being used, the UE can continue execution of the process 2100 by processing the dynamic grant received on PDCCH for the UE's C-RNTI that identifies the particular HARQ process of the plurality of HARQ processes associated with the plurality of PUSCHs and overrules the configured grant for the particular PUSCH of the plurality of PUSCHs to which the particular HARQ process corresponds.

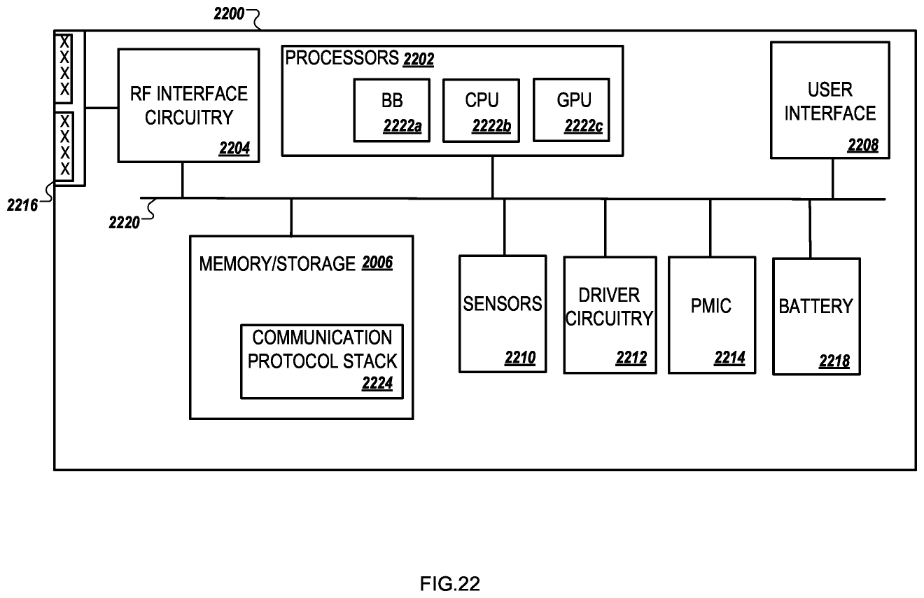

FIG. 22 illustrates a user equipment (UE 2200, according to some implementations. The UE 2200 may be similar to and substantially interchangeable with UE X102 of FIG. X1.

The UE 2200 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 2200 may include processors 2202, RF interface circuitry 2204, memory/storage 2206, user interface 2208, sensors 2210, driver circuitry 2212, power management integrated circuit (PMIC) 2214, antenna structure 2216, and battery 2218. The components of the UE 2200 may be implemented as integrated circuits (ICs), portions thereof, discrete electronic devices, or other modules, logic, hardware, software, firmware, or a combination thereof. The block diagram of FIG. 22 is intended to show a high-level view of some of the components of the UE 2200. However, some of the components shown may be omitted, additional components may be present, and different arrangement of the components shown may occur in other implementations.

The components of the UE 2200 may be coupled with various other components over one or more interconnects 2220, which may represent any type of interface, input/output, bus (local, system, or expansion), transmission line, trace, optical connection, etc. that allows various circuit components (on common or different chips or chipsets) to interact with one another.

The processors 2202 may include processor circuitry such as, for example, baseband processor circuitry (BB) 2222A, central processor unit circuitry (CPU) 2222B, and graphics processor unit circuitry (GPU) 2222C. The processors 2202 may include any type of circuitry or processor circuitry that executes or otherwise operates computer-executable instructions, such as program code, software modules, or functional processes from memory/storage 2206 to cause the UE 2200 to perform operations as described herein.

In some implementations, the baseband processor circuitry 2222A may access a communication protocol stack 2224 in the memory/storage 2206 to communicate over a 3GPP compatible network. In general, the baseband processor circuitry 2222A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 2204. The baseband processor circuitry 2222A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 2206 may include one or more non-transitory, computer-readable media that includes instructions (for example, communication protocol stack 2224) that may be executed by one or more of the processors 2202 to cause the UE 2200 to perform various operations described herein. The memory/storage 2206 include any type of volatile or non-volatile memory that may be distributed throughout the UE 2200. In some implementations, some of the memory/storage 2206 may be located on the processors 2202 themselves (for example, L1 and L2 cache), while other memory/storage 2206 is external to the processors 2202 but accessible thereto via a memory interface. The memory/storage 2206 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 2204 may include transceiver circuitry and radio frequency front module (RFEM) that allows the UE 2200 to communicate with other devices over a radio access network. The RF interface circuitry 2204 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 2216 and proceed to filter and amplify (with a low-noise amplifier) the signal. The signal may be provided to a receiver of the transceiver that downconverts the RF signal into a baseband signal that is provided to the baseband processor of the processors 2202.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 2216. In various implementations, the RF interface circuitry 2204 may be configured to transmit/receive signals in a manner compatible with NR access technologies.

The antenna 2216 may include antenna elements to convert electrical signals into radio waves to travel through the air and to convert received radio waves into electrical signals. The antenna elements may be arranged into one or more antenna panels. The antenna 2216 may have antenna panels that are omnidirectional, directional, or a combination thereof to enable beamforming and multiple input, multiple output communications. The antenna 2216 may include microstrip antennas, printed antennas fabricated on the surface of one or more printed circuit boards, patch antennas, phased array antennas, etc. The antenna 2216 may have one or more panels designed for specific frequency bands including bands in FR1 or FR2.

The user interface 2208 includes various input/output (I/O) devices designed to enable user interaction with the UE 2200. The user interface 2208 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 2200.

The sensors 2210 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2212 may include software and hardware elements that operate to control particular devices that are embedded in the UE 2200, attached to the UE 2200, or otherwise communicatively coupled with the UE 2200. The driver circuitry 2212 may include individual drivers allowing other components to interact with or control various input/output (I/O) devices that may be present within, or connected to, the UE 2200. For example, driver circuitry 2212 may include a display driver to control and allow access to a display device, a touchscreen driver to control and allow access to a touchscreen interface, sensor drivers to obtain sensor readings of sensor circuitry 2210 and control and allow access to sensor circuitry 2210, drivers to obtain actuator positions of electro-mechanic components or control and allow access to the electro-mechanic components, a camera driver to control and allow access to an embedded image capture device, audio drivers to control and allow access to one or more audio devices.

The PMIC 2214 may manage power provided to various components of the UE 2200. In particular, with respect to the processors 2202, the PMIC 2214 may control power-source selection, voltage scaling, battery charging, or DC-to-DC conversion.

In some implementations, the PMIC 2214 may control, or otherwise be part of, various power saving mechanisms of the UE 2200. A battery 2218 may power the UE 2200, although in some examples the UE 2200 may be mounted deployed in a fixed location, and may have a power supply coupled to an electrical grid. The battery 2218 may be a lithium ion battery, a metal-air battery, such as a zinc-air battery, an aluminum-air battery, a lithium-air battery, and the like. In some implementations, such as in vehicle-based applications, the battery 2218 may be a typical lead-acid automotive battery.

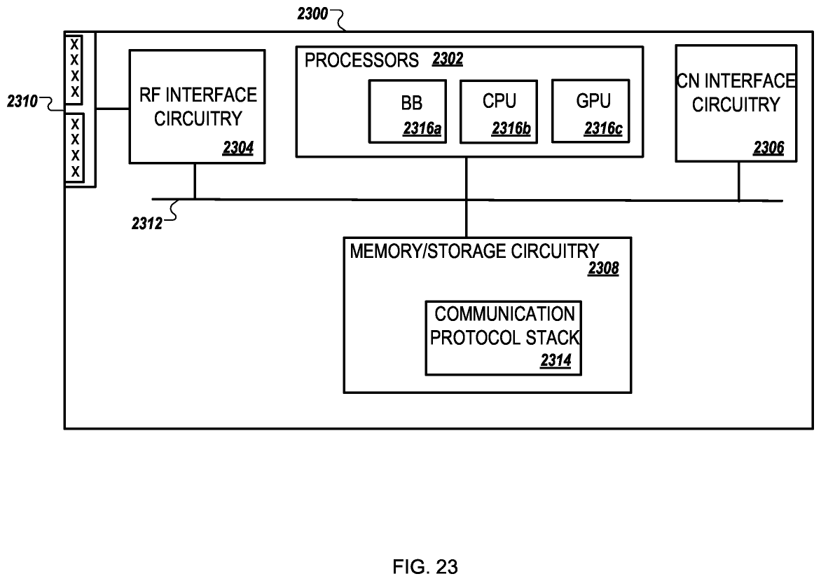

FIG. 23 illustrates an access node 2300 (e.g., a base station or gNB), according to some implementations. The access node 2300 may be similar to and substantially interchangeable with base station 104. The access node 2300 may include processors 2302, RF interface circuitry 2304, core network (CN) interface circuitry 2306, memory/storage circuitry 2308, and antenna structure 2310.

The components of the access node 2300 may be coupled with various other components over one or more interconnects 2312. The processors 2302, RF interface circuitry 2304, memory/storage circuitry 2308 (including communication protocol stack 2314), antenna structure 2310, and interconnects 2312 may be similar to like-named elements shown and described with respect to FIG. 22. For example, the processors 2302 may include processor circuitry such as, for example, baseband processor circuitry (BB) 2316A, central processor unit circuitry (CPU) 2316B, and graphics processor unit circuitry (GPU) 2316C.

The CN interface circuitry 2306 may provide connectivity to a core network, for example, a 5th Generation Core network (5GC) using a 5GC-compatible network interface protocol such as carrier Ethernet protocols, or some other suitable protocol. Network connectivity may be provided to/from the access node 2300 via a fiber optic or wireless backhaul. The CN interface circuitry 2306 may include one or more dedicated processors or FPGAs to communicate using one or more of the aforementioned protocols. In some implementations, the CN interface circuitry 2306 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 2300 that operates in an NR or 5G system (for example, a gNB), and the term “E-UTRAN node” or the like may refer to an access node 2300 that operates in an LTE or 4G system (e.g., an eNB). According to various implementations, the access node 2300 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 2300 may be implemented as one or more software entities running on server computers as part of a virtual network, which may be referred to as a CRAN and/or a virtual baseband unit pool (vBBUP). In V2X scenarios, the access node 2300 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

1-10. (canceled)

11. One or more processors configured to, when executing instructions stored in a memory, perform operations comprising:
receiving a configured grant that schedules a plurality of physical uplink shared channel (PUSCH) transmissions, wherein each PUSCH transmission of the plurality of PUSCH transmissions is associated with a respective hybrid automatic repeat request (HARQ) process of a plurality of HARQ processes;
starting a set of configured grant timers for the plurality of HARQ processes;
receiving a dynamic grant that identifies a HARQ process and overrules the configured grant for a PUSCH transmission associated with the identified HARQ process; and
restarting a configured grant timer for the identified HARQ process using a predetermined timer value.

12. The one or more processors of claim 11, wherein the dynamic grant is received on a physical downlink control channel (PDCCH) and includes a cell radio network temporary identifier (C-RNTI) of a user equipment (UE).

13. The one or more processors of claim 11, the operations further comprising refraining from performing a new transmission using one or more configured grants associated with the identified HARQ process while the restarted configured grant timer is running.

14. The one or more processors of claim 11, wherein the predetermined timer value is a remainder of an initial duration of the configured grant timer associated with the identified HARQ process,

15. The one or more processors of claim 11, wherein the predetermined timer value causes the configured grant timer to expire at a common expiry point established for one or more other HARQ processes corresponding to another PUSCH transmission of the plurality of PUSCH transmissions.

16. The one or more processors of claim 11, the operations further comprising adjusting the predetermined timer value by an offset in response to determining that the dynamic grant does overlap with the configured grant.

17. The one or more processors of claim 16, wherein:
determining that the dynamic grant does not overlap with the configured grant comprises determining that the dynamic grant occurs at a later time than the configured grant and before a common expiry point established for the set of configured grant timers; and
adjusting the predetermined timer value comprises adjusting the predetermined timer value by a negative offset.

18. The one or more processors of claim 11, wherein the predetermined timer value is based at least on a default timer value for the configured grant timer.

19. The one or more processors of claim 11, the operations further comprising:
receiving HARQ acknowledgement (ACK) feedback for the HARQ process identified by the dynamic grant; and
stopping the configured grant timer associated with the identified HARQ process.

20. A method comprising:
receiving a configured grant that schedules a plurality of physical uplink shared channel (PUSCH) transmissions, wherein each PUSCH transmission of the plurality of PUSCH transmissions is associated with a respective hybrid automatic repeat request (HARQ) process of a plurality of HARQ processes;
starting a set of configured grant timers for the plurality of HARQ processes;
receiving a dynamic grant that identifies a HARQ process and overrules the configured grant for a PUSCH transmission associated with the identified HARQ process; and
restarting a configured grant timer for the identified HARQ process using a predetermined timer value.

21. The method of claim 20, wherein the dynamic grant is received on a physical downlink control channel (PDCCH) and includes a cell radio network temporary identifier (C-RNTI) of a user equipment (UE).

22. The method of claim 20, further comprising refraining from performing a new transmission using one or more configured grants associated with the identified HARQ process while the restarted configured grant timer is running.

23. The method of claim 20, wherein the predetermined timer value is a remainder of an initial duration of the configured grant timer associated with the identified HARQ process,

24. The method of claim 20, wherein the predetermined timer value causes the configured grant timer to expire at a common expiry point established for one or more other HARQ processes corresponding to another PUSCH transmission of the plurality of PUSCH transmissions.

25. The method of claim 20, further comprising adjusting the predetermined timer value by an offset in response to determining that the dynamic grant does overlap with the configured grant.

26. The method of claim 25, wherein:
determining that the dynamic grant does not overlap with the configured grant comprises determining that the dynamic grant occurs at a later time than the configured grant and before a common expiry point established for the set of configured grant timers; and
adjusting the predetermined timer value comprises adjusting the predetermined timer value by a negative offset.

27. The method of claim 20, wherein the predetermined timer value is based at least on a default timer value for the configured grant timer.

28. The method of claim 20, further comprising:
receiving HARQ acknowledgement (ACK) feedback for the HARQ process identified by the dynamic grant; and
stopping the configured grant timer associated with the identified HARQ process.

29. An apparatus comprising:
a memory;
a transceiver; and
a processor coupled to the memory and configured to, when executing instructions stored in the memory, cause the apparatus to perform operations comprising:
receiving a configured grant that schedules a plurality of physical uplink shared channel (PUSCH) transmissions, wherein each PUSCH transmission of the plurality of PUSCH transmissions is associated with a respective hybrid automatic repeat request (HARQ) process of a plurality of HARQ processes;
starting a set of configured grant timers for the plurality of HARQ processes;
receiving a dynamic grant that identifies a HARQ process and overrules the configured grant for a PUSCH transmission associated with the identified HARQ process; and
restarting a configured grant timer for the identified HARQ process using a predetermined timer value.

30. The apparatus of claim 29, wherein the dynamic grant is received on a physical downlink control channel (PDCCH) and includes a cell radio network temporary identifier (C-RNTI) of a user equipment (UE).
